(19) United States
(12) Patent Application Publication
(10) Pub. No.: US 2007/0289753 A1
(43) Pub. Date: Dec. 20, 2007

(54) Aerator Apparatus

(76) Inventor: Wilfred Wiebe, Medicine Hat (CA)

Correspondence Address: Bay Area Patent Group, LLC, 13630 58TH ST. NORTH, SUITE 101, CLEARWATER, FL, 33760, US

(21) Appl. No.: 11/424,879

(22) Filed: Jun. 19, 2006

(51) Int. Cl. A01B 45/02

(52) U.S. Cl. 172/21

(57) ABSTRACT

An apparatus for aerating lawns or the like for forming a plurality of holes in a turf surface and the underlying ground having a wheeled frame supporting an electric motor that is coupled to a pair of perforation bits through a coupling drive which imparts rotational motion to each bit. The bits are held at a fixed vertical position relative to the frame and a pair of wheels are attached to the frame rearward of the bits, such that the frame is rotatable through an arcuate path about the center of rotation of the pair of wheels. An operator rotates the frame forward to insert the bits through the turf surface and underlying ground and rotates the frame rearward to remove the bits. The bits are designed to push the underlying ground in a direction downward and transversely to each bit as it is makes a hole to prevent the underlying ground from displacing in a direction upward and out of the hole.

### FIELD OF THE INVENTION

The present invention relates generally to turf aeration. More particularly, relating to a mobile turf aerating apparatus for forming a multiplicity of boreholes in a terrain so as to improve the penetration of water and or fertilizer through the turf surface having an improved and simplified construction

### BACKGROUND OF THE INVENTION

To improve growth of turf and to prevent a turf condition called “brown patch”, it is desirable to aerate the turf soil to allow water and or fertilizer to more readily penetrate the underlying ground providing a better supply of water and or fertilizer to the underlying roots of the turf. It is common to aerate the soil by punching a plurality holes into the ground spaced over the turf surface through the use of a hand tool, such as a pitch fork, or by a turf perforating apparatus.

Prior art devices have been designed in the form of hand operated and powered turf perforating machines for the aforementioned purposes, examples of which are shown in U.S. Pat. Nos. 3,621,920; 4,154,305; 4,511,004; 3,566,973; 4,476,938; 2,303,726; 2,206,264; 2,255,040; 2,728,283; and 3,136,274, each of which disclose wheeled vehicles carrying one or a plurality of spike members which are vertically reciprocated to form holes in the turf surface. However, in each of case these prior devices utilize a complex arrangement of chains, gears, and other means to drive the spike members into the turf surface which render them somewhat less than satisfactory for use by a residential homeowner.

### SUMMARY OF THE INVENTION

The present invention is directed to a powered, mobile turf aerating apparatus of simplified construction which overcomes the disadvantages of prior art devices and which in addition includes functional and other technical features not heretofore found. The simplified construction of the aerating apparatus of the present invention eliminates all of the complicated linkages present in the prior aerating devices for driving perforating spike members into the turf and underlying soil, and in doing so the aerating apparatus of the present invention is less complicated to operate and service, is more reliable and is less expensive to manufacture.

In general, in one aspect, an aerating apparatus for penetrating a turf surface and forming a plurality of boreholes within the earth is provided. The aerating apparatus includes a vertical frame having a top end, and a bottom end and a pair of opposed wheels attached to the vertical frame at a fixed vertical position along the vertical frame, the pair of opposed wheels provide rolling support to the vertical frame such the said vertical frame is free to rotate forward and rearward in an arcuate path about the rotational axis of the pair of opposed wheels; a prime mover having a drive shaft is supported by the vertical frame; a first and second perforating bit, each having a turf penetrating end and an opposed attachment end and a drive means for coupling the drive shaft of the prime mover to the attachment end of each of the first and the second perforating bits so that each of bit axially rotates; a handle attached to the vertical frame approximate the top end; and the first and second perforating bits being positioned forward of the opposed wheels, whereby forward rotation of the vertical frame about the rotational axis of the pair of opposed wheels causes the penetrating end of each perforating bits to penetrate a turf surface.

In general, in another aspect, the turf penetrating end of each of the first and the second perforating bits includes a concaved penetrating surface that displaces earth in a direction downwardly and transversely of the respective bit as the respective bit forms a borehole into the earth, thereby preventing earth being displaced upwardly and out of the borehole to minimize contamination of the turf surface with the underlying earth.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of an aeration apparatus constructed in accordance with the principles of the present invention;

FIG. 2 is a top plan view of the aeration apparatus of FIG. 1;

FIG. 3 is a partial front elevation view of the aeration apparatus of FIG. 1, showing further detail of the drive means;

FIG. 4 is a cross sectional view taken along line 3-3 in FIG. 2, showing a top elevation of the drive means;

FIG. 5 is the cross sectional view of FIG. 3 showing an second embodiment of the drive means which includes a belt tensioner;

FIG. 6 is a side elevation view of the aeration apparatus illustrating how the frame is supported by the wheels and is rotatable about the axis of rotation of the wheels;

FIG. 7 is a partial side elevation view of the aeration apparatus showing the bits penetrating into the ground; and

FIG. 8 is a front elevation pictorial view of a pair of bits showing further detail of the each bit configuration.

The same reference numerals refer to the same parts throughout the various figures.

### DETAILED DESCRIPTION OF THE INVENTION

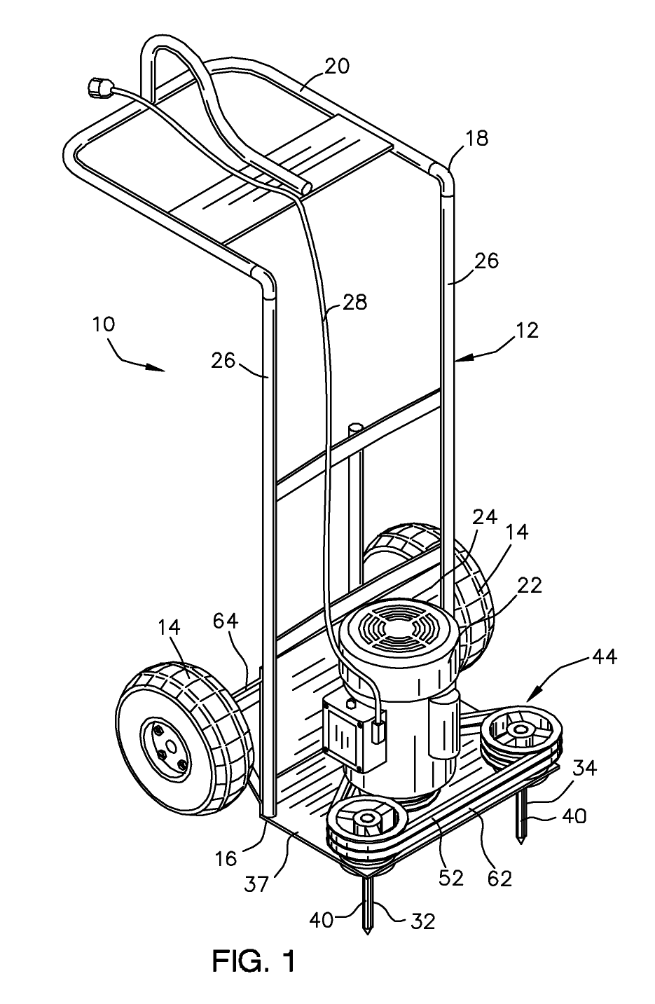

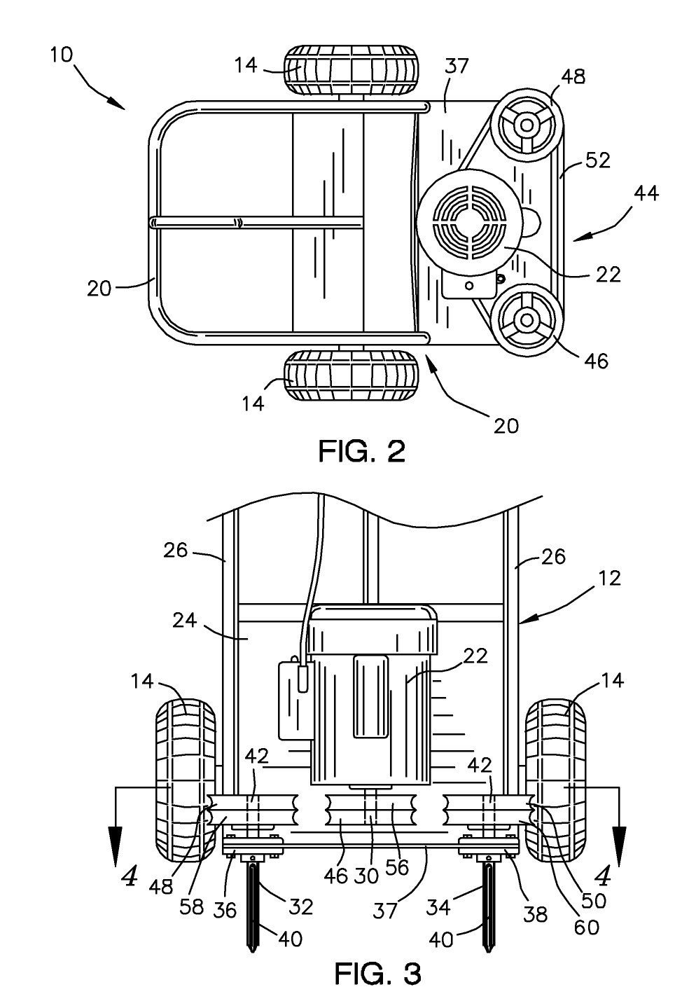

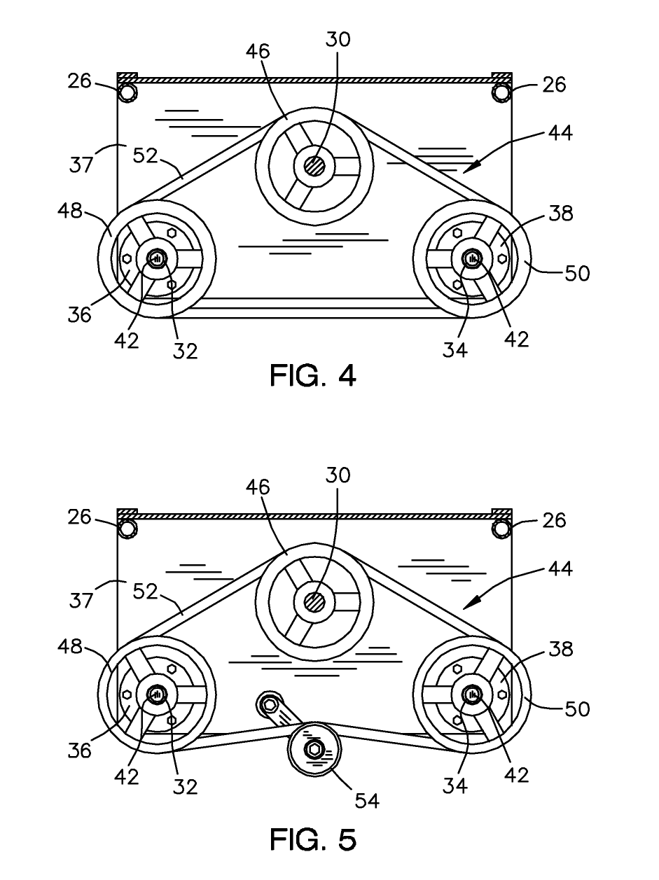

Referring now to FIGS. 1-8 of the drawings, an aerating apparatus of this invention is designated generally as 10. The aerating apparatus 10 includes a vertical frame 12 supported on a pair of wheels 14 at a bottom end 16 and terminating at a top end 18 in a handle 20 for gripping and guiding by an operator. The handle 20 is generally U-shaped with the each leg being attached to the frame 12 and extending in a direction generally backward from the frame.

A prime mover 22 is supported by the frame 12 by a mounting plate 24 which spans two spaced vertical members 26 of the frame. The prime mover 22 is depicted as an electric motor which is connected by a cord 28 to a source of electrical power and energized by the actuation of a switch. Alternatively, the prime mover 22 could be a battery-powered cordless motor or a gasoline-powered motor or the like. The output shaft 30 of the prime mover 22, which typically revolves at or near a speed of 1740 revolutions per a minute, extends vertically downward therefrom.

A pair of vertical perforating bits 32 and 34 are support by a first and a second rotary bearing assembly 36 and 38 respectively which are attached to a perforating bit support member 37 that extends outward in a direction forward of the frame 12 approximate the bottom end 16. The perforating bit support member 36 is fixedly attached to the frame 12 and moves along with the frame. The perforating bit support member 37 is shown as a solid plate spanning between the vertical members 26 of the frame 12 and extending perpendicularly from the frame 12 in a forward direction. However it is contemplated the perforating bit support member 36 could take on various other forms or constructions. The perforating bits 32 and 34 are positioned at a fixed vertical position relative to the frame 12 and are not permitted to reciprocate vertically. Each perforating bit 32 and 34 includes a turf penetrating end 40 and an opposed attachment end 42.

The perforating bits 32 and 34 are caused to rotate axially through a drive means 44 which drivingly couples the output shaft 30 of the prime mover 22 to the attachment end 42 of each perforating bit. The drive means 44 includes a first pulley 46 attached to the output shaft 30 of the prime mover, a second pulley 48 attached to the attachment end 42 of the first perforating bit 32, a third pulley 50 attached to the attachment end 42 of the second perforating bit 34, and a drive belt 52 spanning about and engaged with the first, second and third pulleys. In this arrangement, the rotational energy of the output shaft 30 is transmitted to each perforating bit 32 and 34 through the drive belt 50. A belt tensioner 54 can be provided to keep the drive belt 52 tensioned and engaged with the first, second and third pulleys 46, 48, and 50. The first, second, and third pulleys 46, 48, and 50 are each arranged co-planner to one another to reduce side loading on the drive belt 52.

In a second arrangement to reduce belt slippage, a fourth pulley 56 is attached to the output shaft 30 in coaxial alignment with the first pulley 46, a fifth pulley 58 is attached to the attachment end 42 of the first perforating bit 32 in coaxial alignment with the second pulley 48, a sixth pulley 60 is attached to the attachment end 42 of the second perforating bit 34 in coaxial alignment with the third pulley 50, and a second drive belt 62 spans about and engages the fourth, fifth and sixth pulleys. The first and fourth pulleys 46 and 56 are of a greater diameter than the second, third, fifth and sixth pulleys 48, 50, 58, and 60 to increase the rotational speed of the second, third, firth and sixth pulley. The first, second, and third pulleys 46, 48, and 50 are each arranged co-planner to one another to reduce side loading on the drive belt 52,

In either of the above arrangements, each pulley is of a heavy weight material or is weighted to increase the rotational momentum of the drive means 44 and ultimately to each perforating bit 32 and 34 to prevent or reduce the prime mover 22 from bogging down, or in other words to prevent a reduction in rotational speed as each perforation bit is inserted through a turf surface to create a borehole in the underlying ground or soil.

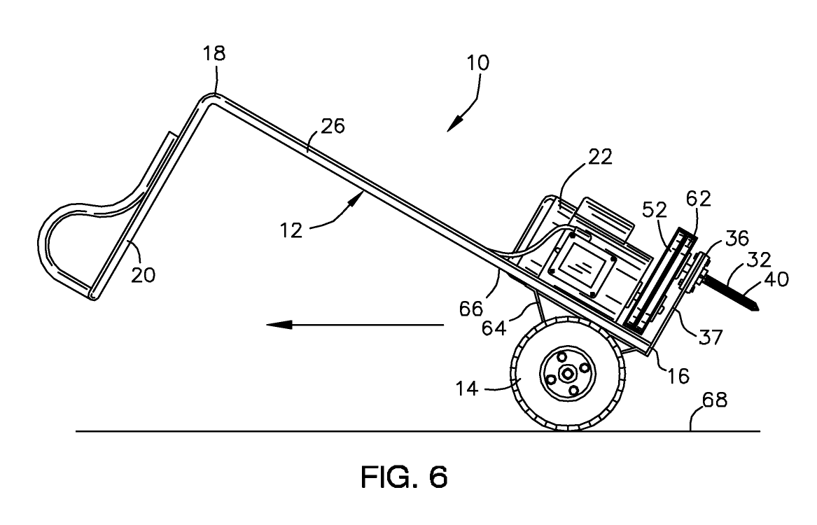

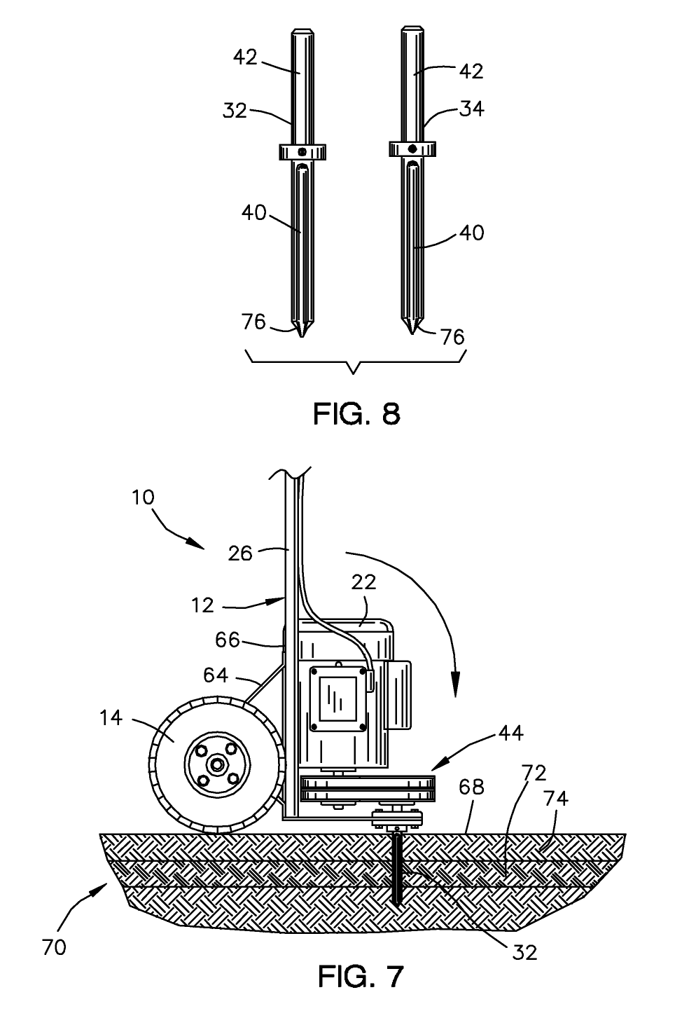

With particular reference to FIGS. 6 and 7, each bit 32 and 34 is positioned forward of the pair of wheels 14. The pair of wheels are attached to the frame 12 at a fixed vertical position along the frame through rigid struts 64 which are attached to and extend from a rearward facing side 66 of the frame. The frame 12, supported by the pair of wheels 12 is rotatable in a forward and rearward direction through an arcuate path about the axis of rotation of the pair of wheels. The frame 12 is rotated in the forward direction to insert each bit 32 and 34 through the turf surface 68 into the underlying ground 70, and is rotated backward to remove each bit from the ground and to clear the turf surface. Each bit 32 and 34 is of a length such that the turf penetrating end 40 of each bit extends beyond the bottom end 16 of the frame 12 a distance that is sufficient for each bit to penetrate the turf surface 68 and form a borehole in the underlying ground 70. Ideally, when there exists a clay strata 72 below a strata of top soil 74, each bit 32 and 34 is of a length sufficient to pass through the clay strata. The depth of penetration of each bit 32 and 34 can be controlled by the operator by limiting the forward rotation of the frame 12 to a point were a desired depth is achieved.

Now with reference to FIG. 8, which shows a set of bits 32 and 34, each bit includes an attachment end 42, a turf penetrating end 40 having penetrating surface 76 that is tapered and can be generally concaved-shaped. The penetrating surface 76 of each bit 32 and 34 displaces ground 70 in a downwardly and a transverse direction to each bit as it is inserted into the ground. By displacing the ground 70 downwardly and radially outwardly, the is ground prevent from being displaced in a direction upward and out of the borehole formed into the ground by the bit to prevent contamination of the turf surface 68 by the underlying ground 70. Minimizing contamination is particularly important when a clay strata 72 is present, as clay is relatively nutritionally deficient and depositing clay on the turf surface 68 results in damage to the turf. Each bit 32 and 34 can be vertically fluted to further aid in displacing the ground 70 in a downwardly and a transverse direction as the bit is inserted into the ground.

In use, it can now be understood, an operator would first position the aerating apparatus 10 a starting point along a terrain, and while stand behind the frame 12 grasp the handle 20. The operator would then rotate the frame 12 forward driving each rotating bit 32 and 34 through a turf surface into the underlying ground until each bit is inserted into the ground a desired depth and then rotate the frame backward until each bit removed from the ground and is clear of the turf surface. The operator, while the frame 12 is rotated backward sufficiently to clear the each bit 32 and 34 from the turf surface, takes a step backward and then rotate the frame forward to drive each bit into the ground once again. This process is repeated until a desired number of boreholes or perforations are made through the turf surface and underlying ground.

A number of embodiments of the present invention have been described. Nevertheless, it will be understood that various modifications may be made without departing from the spirit and scope of the invention. Accordingly, other embodiments are within the scope of the following claims.

I claim:

1. An aerating apparatus for penetrating a turf surface and forming a plurality of boreholes within the earth, the aerating apparatus comprising:
a vertical frame having a top end, and a bottom end;
a pair of opposed wheels attached to said vertical frame at a fixed vertical position along said vertical frame, said pair of opposed wheels for providing rolling support to said vertical frame such that said vertical frame is free to rotate forward and rearward in an arcuate path about the rotational axis of said pair of opposed wheels;
a prime mover having a drive shaft and being supported by said vertical frame;
first and second perforating bits, each having a turf penetrating end and an opposed attachment end;
a drive means for coupling said drive shaft of said prime mover to said attachment end of each of said first and said second perforating bits, thereby causing each of said first and said second perforating bits to axially rotate;
a handle attached to said vertical frame approximate said top end; and
said first and second perforating bits being positioned forward of said opposed wheels, whereby forward rotation of said vertical frame about the rotational axis of said pair of opposed wheels causes said penetrating end of each of said first and said second perforating bits to penetrate a turf surface.

2. The aerating apparatus of claim 1, wherein said turf penetrating end of each of said first and said second perforating bits includes a concaved penetrating surface that displaces earth in a direction downwardly and transversely of said respective bit as said respective bit forms a borehole into the earth, thereby preventing earth to be displaced upwardly and out of the borehole to minimize contamination of the turf surface with earth below the turf surface.

3. The aerating apparatus of claim 1, wherein said prime mover is an electrical motor.

4. The aerating apparatus of claim 1, wherein said drive means includes:
a first pulley attached to said drive shaft of said prime mover;
a second pulley attached to said attachment end of said first perforating bit;
a third pulley attached to said attachment end of said second perforating bit; and
a drive belt drivingly engaged with said first, second and third pulleys.

5. The aerating apparatus of claim 4, further comprising:
a belt tensioner engaged with said drive belt.

6. The aerating apparatus of claim 4, further comprising:
a fourth pulley attached to said drive shaft of said prime mover in coaxial alignment with said first pulley;
a fifth pulley attached to said attachment end of said first perforating bit in coaxial alignment with said second pulley;
a sixth pulley attached to said attachment end of said second perforating bit in coaxial alignment with said third pulley; and
a second drive belt drivingly engaged with said fourth, said first and said sixth pulleys.

7. The aerating apparatus of claim 1, wherein said pair of opposed wheels are positioned rearward of said rearward facing side of said vertical frame.

8. The aerating apparatus of claim 1, wherein said handle extends in a direction rearwardly of said vertical frame.

9. The aerating apparatus of claim 1, further comprising:
a perforating bit support member attached to said vertical frame and extending forwardly therefrom;
a first bearing assembly supported by said perforating bit support and rotatably receiving said first perforating bit; and
a second bearing assembly supported by said perforating bit support and rotatably receiving said second perforating bit.

10. An aerating apparatus for penetrating a turf surface and forming a plurality of boreholes within the earth, the aerating apparatus comprising:
a vertical frame having a top end, and a bottom end;
a pair of opposed wheels attached to said vertical frame at a fixed vertical position along said vertical frame, said pair of opposed wheels for providing rolling support to said vertical frame such that said vertical frame is free to rotate forward and rearward in an arcuate path about the rotational axis of said pair of opposed wheels;
a prime mover having a drive shaft and being supported by said vertical frame;
a perforating bit support attached to said vertical frame approximate said bottom end and extending outwardly in a direction forward of said vertical frame;
first and second perforating bits, each having a turf penetrating end and an opposed attachment end, said first and second perforating bits being supported by said perforating bit support at a fixed vertical position relative to said vertical frame;
a drive means for coupling said drive shaft of said prime mover to said attachment end of each of said first and said second perforating bits, thereby causing each of said first and said second perforating bits to axially rotate;
a handle attached to said vertical frame approximate said top end; and
said first and second perforating bits being positioned forward of said opposed wheels, whereby forward rotation of said vertical frame about the rotational axis of said pair of opposed wheels causes said penetrating end of each of said first and said second perforating bits to penetrate a turf surface.

11. The aerating apparatus of claim 10, wherein said turf penetrating end of each of said first and said second perforating bits extends beyond said bottom end of said vertical frame.

12. The aerating apparatus of claim 10, wherein said turf penetrating end of each of said first and said second perforating bits includes a concaved penetrating surface that displaces earth in a direction downwardly and transversely of said respective bit as said respective bit forms a borehole into the earth, thereby preventing earth to be displaced upwardly and out of the borehole to minimize contamination of the turf surface with earth below the turf surface.

13. The aerating apparatus of claim 10, wherein said prime mover is an electrical motor.

14. The aerating apparatus of claim 10, wherein said drive means includes:
a first pulley attached to said drive shaft of said prime mover;
a second pulley attached to said attachment end of said first perforating bit;
a third pulley attached to said attachment end of said second perforating bit; and
a drive belt drivingly engaged with said first, second and third pulleys.

15. The aerating apparatus of claim 14, further comprising:
a belt tensioner engaged with said drive belt.

16. The aerating apparatus of claim 14, further comprising:
a fourth pulley attached to said drive shaft of said prime mover in coaxial alignment with said first pulley;
a fifth pulley attached to said attachment end of said first perforating bit in coaxial alignment with said second pulley;
a sixth pulley attached to said attachment end of said second perforating bit in coaxial alignment with said third pulley; and
a second drive belt drivingly engaged with said fourth, said first and said sixth pulleys.

17. The aerating apparatus of claim 10, further comprising:
a first bearing assembly supported by said perforating bit support and rotatably receiving said first perforating bit; and
a second bearing assembly supported by said perforating bit support and rotatably receiving said second perforating bit.
